(19) United States
(12) Patent Application Publication
(10) Pub. No.: US 2007/0285871 A1
(43) Pub. Date: Dec. 13, 2007

(54) Bar Type Corona Discharged Electrostatic Eliminator Equipped With Air Vessel Using Pulse Ac High Voltage Power Source

(76) Inventor: Dong-Hoon Lee, Pusan (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/660,153

(22) PCT Filed: Mar. 15, 2005
(86) PCT No.: PCT/KR05/00745

§ 371 Date: Feb. 13, 2007

(30) Foreign Application Priority Data
Aug. 13, 2004 (KR) 10 2004 0064064

(51) Int. Cl. H01T 19/00; H05F 3/00

(52) U.S. Cl. 361/235

(57) ABSTRACT

This invention relates to an equipment for eliminating static electricity, more specifically speaking, compared to the voltage applied to the discharging electrode in prior corona discharged electrostatic eliminator is a simple AC High Voltage or DC High Voltage, in this invention, a Pulse AC High Voltage coupled with a signal of square pulse type is applied, and by preparing an air vessel into the equipment and sending air of regular pressure through a minute air nozzle, the equipment of this invention can move the ions to a charged body. The corona discharged electrostatic eliminator of this invention comprises a discharging electrode that generates a corona discharge, a ground electrode that inducts ion generation from the voltage applied discharging electrode, a High voltage unit that generates an AC pulse high voltage and applies it to the discharging electrode, and a controller to control the frequency and Duty Ratio of the AC pulse high voltage, wherein the range of the frequency of the high voltage is from 1 [Hz] to 10 [kHz], and the duty ratio is controlled in the 40˜60[%] range. The electrostatic eliminator of this invention can eliminate the remaining static electricity of the charged body efficiently regardless of the distance to the charged body through the free control of the frequency and duty ratio of the applied voltage.

### TECHNICAL FIELD

This invention relates to an electrostatic eliminator by using the corona discharge, particularly that moves ions by spraying air in an air vessel with a minute air nozzle, in moving generated ions to a charged body.

### BACKGROUND ART

Generally, in producing semiconductor, liquid crystal display (LCD), plasma display panel (PDP), organic EL, multi-layer ceramic condenser (MLCC), etc, a very clean workroom is necessary. Yet especially in the process of printing, spreading and cleaning them we treat a large quantity of high-isolated substances to which the static electricity is charged easily, at this time for reasons of sticking of a foreign body like the dust by the static electricity the problems like fall of yield, destruction of patterns, and bad printing rise.

As described above, in the course of treating high-isolated substances the need for eliminating the static electricity of the charged body is required frequently, and to eliminate this static electricity corona discharged electrostatic eliminator is used widely. The way of using common corona discharged electrostatic eliminator can be divided into 2 according to the applied voltage style, using DC high voltage and AC high voltage. AC high voltage corona discharged electrostatic eliminator mainly uses the common frequency (60 Hz) and high frequency (10 kHz˜18 kHz), while DC high voltage corona discharged electrostatic eliminator uses DC high voltage (about ±7 kV).

However, AC high voltage style is suitable for eliminating the static electricity at a short distance (50 mm˜300 mm) from the charged body but not suitable for eliminating the static electricity of the far apart charged body. Moreover using high frequency is suitable for eliminating the static electricity of a charged body moving at a high speed, but it also has the problem of the unbalance between the amount of +ions and −ions generated by the electrostatic eliminator for reason of the difference of the produced amount of +ions and −ions, so it cannot eliminate the remaining static electricity perfectly.

Meanwhile DC high voltage style is installed at a long distance over 1,000 mm form the charged body and can eliminate the static electricity so it is mainly used when the installed distance is long but is not suitable for the installation of a short distance.

Therefore the invention of an electrostatic eliminator is required urgently, which is suitable for both short and long distance, furthermore, which can eliminate the remaining static electricity of the charged body more efficiently by solving the problem of the unbalance between the amount of +ions and −ions.

### DISCLOSURE OF INVENTION

Technical Problem

To improve the defects of said DC high voltage and AC high voltage corona discharged electrostatic eliminator, this invention aims to offer an electrostatic eliminator that uses pulse AC high voltage style, in which an air vessel is installed to spray the ions generated at the discharging electrode in the air more efficiently, and that can enhance the efficiency of eliminating the static electricity by forming an air nozzle at the socket of the discharging electrode and sending the generated ions far away as soon as possible.

Technical Solution

The electrostatic eliminator of this invention to achieve said purpose comprises

a discharging electrode (10) that generates a corona discharge;

a ground electrode (30) that inducts ion generation from the voltage applied discharging electrode;

a high voltage generating unit (40) that generates an AC pulse high voltage and applies it to the discharging electrode (10); and

a controller (50) to control the frequency and duty ratio of the AC pulse high voltage, wherein the range of the frequency of the high voltage is from 1 [Hz] to 17 [kHz], and the duty ratio is controlled in the 40˜60[%] range.

Moreover the electrostatic eliminator of this invention preferably further comprises a discharging electrode socket (20) in which an air nozzle (22) is formed to spray air of regular pressure, so that the ions generated at the discharging electrode (10) can be sent to a charged body; and

an air vessel that joined directly to said discharging electrode socket and supplies air injected through an air injection part (61,62) to said air nozzle.

Advantageous Effects

According to the pulse AC high voltage corona discharged electrostatic eliminator of this invention, since the control of the frequency according to the installed distance and the control of the duty ratio to control the voltage of the remaining static electricity can be set freely, the defects of the prior DC and AC high voltage corona discharged electrostatic eliminator is complemented sufficiently and the effect of eliminating the static electricity can be improved.

That is by using AC high voltage type but controlling generated amount of ions and velocity of generating ions properly, eliminating static electricity can be done efficiently, and can send generated ions efficiently to the charged body located at long distance through the discharging electrode socket in which the air nozzle is formed.

### BRIEF DESCRIPTION OF THE DRAWINGS

FIG. 1 illustrates an overall structure of an electrostatic eliminator according to this invention.

FIG. 2 illustrates a detailed structure of a discharging electrode socket in which an air nozzle is formed according to this invention.

FIG. 3 illustrates a preferred embodiment of a circuit for a high voltage generating unit generating a pulse AC high voltage.

FIG. 4 illustrates a block diagram indicating the structure of a controller to control the electrostatic eliminator according to this invention.

FIG. 5 is a flow chart indicating the operating principle of a controller according to this invention.

FIG. 6 illustrates ions generated by the AC high voltage type according to the prior art.

FIG. 7 illustrates ions generated by the pulse type according to the present invention.

### BEST MODE FOR CARRYING OUT THE INVENTION

Now referencing the attached drawings, we make a detailed explanation about the electrostatic eliminator of this invention.

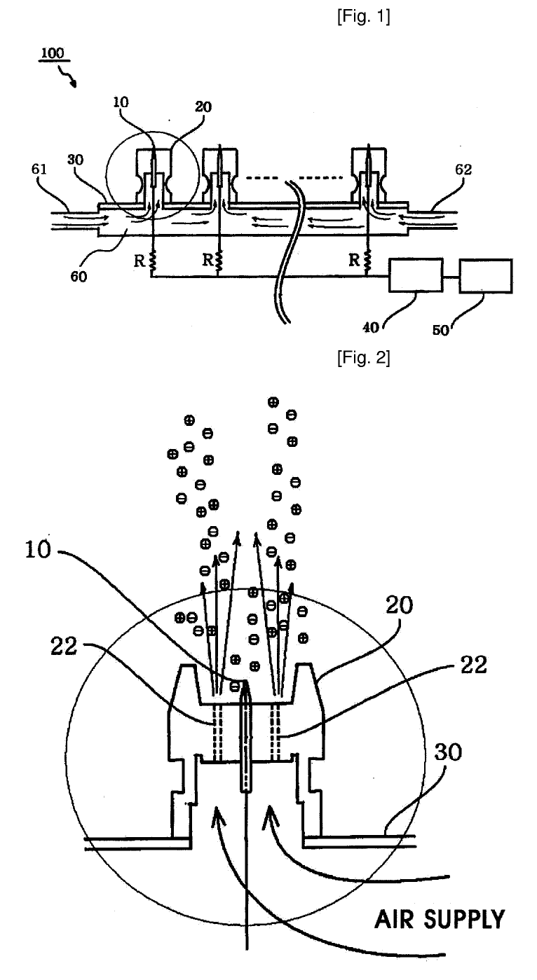

FIG. 1 is a structural view of an electrostatic eliminator according to this invention. As illustrated, the electrostatic eliminator of this invention comprises a discharging electrode (10), a discharging electrode socket (20), a ground electrode (30), a high voltage generating unit (40), a controller (50), an air vessel (60), and a protection resistor R.

Here, the discharging electrode (10) has a function generating the corona discharge that generates +ions and −ions.

The discharging electrode socket (20) protects the discharging electrode (10) from external impact, and has an air nozzle (22) to spray air. The air nozzle (22) functions as a passage of air of regular pressure to move the generated ions at the discharging electrode (10) to the charged body.

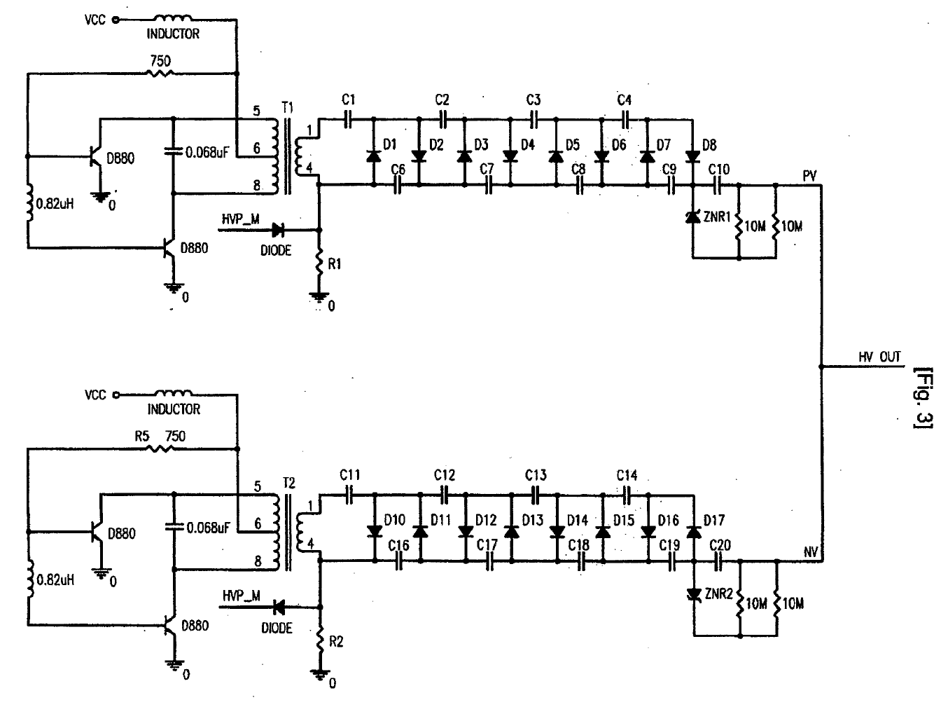

Detailed structure of a discharging electrode socket (20) is illustrated in FIG. 2. As illustrated, the discharging electrode (10) is inserted at the center of the inside of the discharging electrode socket (20), and centering around the discharging electrode (10) an air nozzle (22) having the form of a cylinder that passes through the discharging electrode socket (20) is formed on both sides.

Numbers of the air nozzle (22) can be formed as occasion demands on both sides or along the circumference of the discharging electrode (10), and in order to spray more powerful air, the diameter needs to be small, preferably ø1 mm and less, more preferably about ø0.3 mm.

Meanwhile, the air sprayed through said air nozzle (22) is supplied through the air vessel (60) in which air of regular pressure is injected. That is since each of the air injection part (61,62) is connected to an air blower (not shown), air of regular pressure is always injected to the air vessel (60), so the air sprayed by the air nozzle (22) formed at the discharging electrode socket (20) can maintain regular pressure.

The electrostatic eliminator shown in FIG. 1 is structured that air is injected through the air injection part (61,62) formed at both sides of the air vessel, and the air injection part can be installed at only one side of the air vessel (60) or can be installed at numbers of proper positions.

Meanwhile, a resistor R is connected to the discharging electrode (10), which generates corona discharge stably, and reduces the impact caused by the electric shock when the human body touches with the discharging electrode by reducing the amount of the electric current.

The ground electrode (30) plays a roll in inducting ion generation from the voltage applied discharging electrode (10).

FIG. 3 illustrates an example of an circuit for embodying the high voltage generating unit (40) that generates a pulse AC high voltage. The operation of the circuit in FIG. 3 is as follows. In this embodiment, we preferably make input voltage to be DC 24[V] and oscillation frequency to be 18 [KHz]. The inputted voltage is raised to 200[V] by the inverter transformer (T1, T2), and the raised electric signal is converted to DC high voltage of ±7,000[V] through the voltage multiplier (C1˜C20, D1˜D17). This DC high voltage is outputted as a bilateral square pulse AC high voltage through the Zener diode (ZNR 1˜2), and this output signal is applied to the discharging electrode.

Besides, the circuit of the high voltage generating unit (40) according to this invention comprises the Feedback circuit (R1, R2) to sense the abnormity of the voltage raised at the secondary coil of the inverter transformer. That is, when the current does not flow through the secondary coil of the transformer because of the abnormity of the system the discharge is not generated at the discharging electrode, and the current flows through the resistor so that the feedback of the drop in voltage happens. Moreover to prevent the leakage of the high voltage, the inside is filled up with epoxy resin at a vacuous condition.

As described above, the high voltage unit of this invention comprises a transformer that raises the input voltage, a voltage multiplier that receives the raised voltage from said transformer and generates a high voltage that is applied to the discharging electrode, a pulse converter to convert the high voltage from said voltage multiplier to a pulse type.

Moreover, as described above, the high voltage unit may further comprise a feedback circuit that can get feedback of the drop in voltage by flowing the current through the grounded resistor connected to the secondary coil if a problem that the current does not flow through the secondary coil of said transformer occurs.

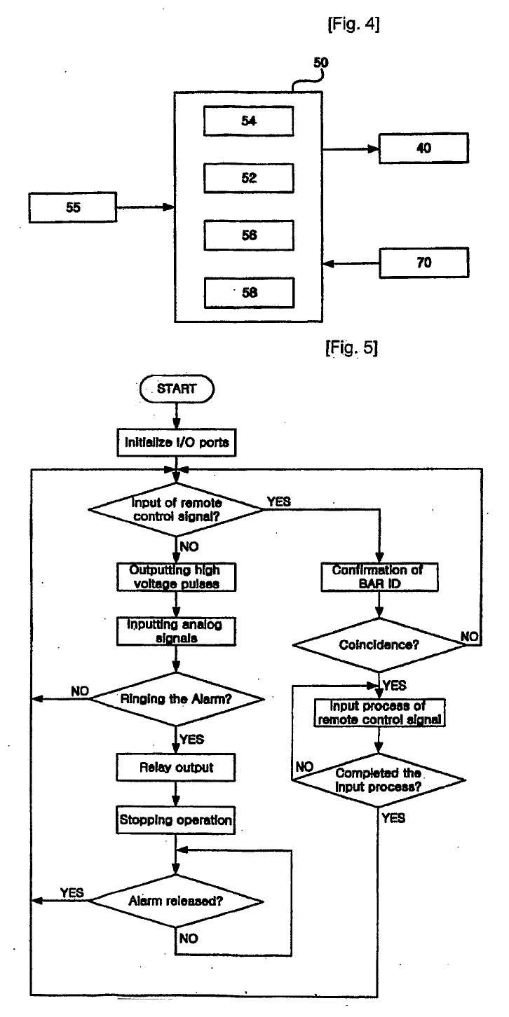

FIG. 4 is a block diagram that indicates the structure of the controller (50) to control the electrostatic eliminator of this invention. The controller (50) comprises an adjusting unit (52) to adjust the frequency and the duty ratio of the pulse AC high voltage, a data communication module (54) to confirm the status of the controller from an external computer by using data communication (RS-485), a remote control signal receiving module (56) to control the frequency and the duty ratio remotely, and an LED controller (58) to control LED. 55 is a remote controller and 70 is an analog feedback signal. It was designed to control the frequency and the duty ratio of the pulse AC high voltage by using a microprocessor, and supply the control signal to the High voltage generating unit (40) (H/V unit). Preferably the signal outputted from the high voltage generating unit (40) is controlled to be in the 1 [Hz]˜10 [kHz] range, and the duty ratio is controlled to be in the 40˜60[%] range. Since the technical feature of the control of frequency and duty ratio by using a microprocessor is common, detailed explanation is omitted.

Like this, the electrostatic eliminator of this invention can convert the frequency of the voltage signal applied to the discharging electrode, a signal of low frequency is applied if the charged body is far away while a signal of high frequency is applied if the charged body is near.

At low frequency, because each bandwidth of + and −ions generated at the discharging electrode gets wide and accordingly the time of going away from each other in the band of ions by the repulsive power gets long, so sending the ions far is easy, on the contrary at high frequency, because the bandwidth of ions gets relatively narrow and accordingly the time of going away from each other by the repulsive power gets short so sending the ions far is relatively difficult.

For example, in case of the duty ratio is 1, at the frequency of 1 Hz +ions and −ions are generated by turns at intervals of 0.5 second, but at the frequency of 1 kHz +ions and −ions are generated by turns at intervals of 0.005 second. Therefore since at low frequency of 1 Hz the bandwidth of ions is generated for 0.5 second but at frequency of 1 kHz it is generated for 0.005 second, the bandwidth at low frequency is wider and the amount of ions generated for each period at low frequency is more and the time for moving by the repulsion of the ions of same polarity in the band of ions at low frequency is longer.

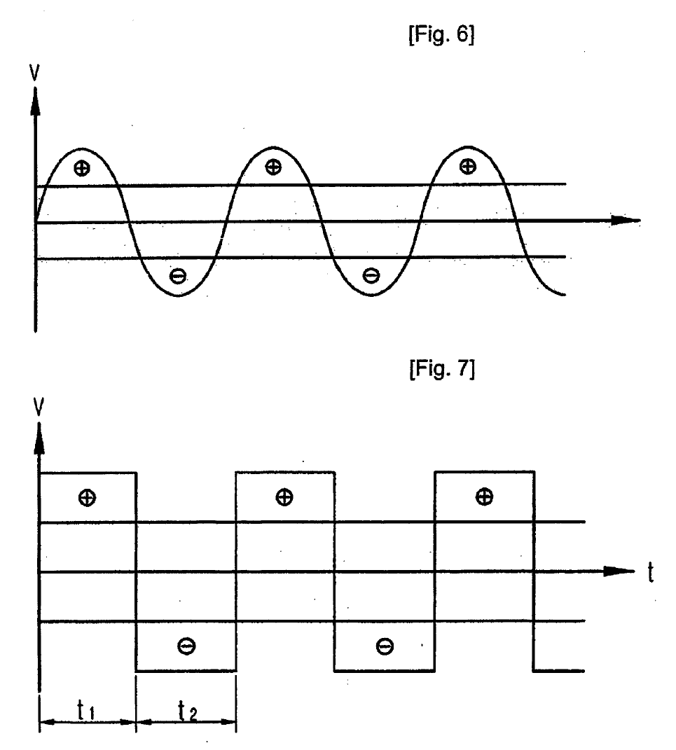

Meanwhile in connection with FIG. 6, the ratio of +ions generating time (t1) and −ions generating time (t2) at one period of the voltage signal applied to the discharging electrode, that is the duty ratio is now illustrated. By controlling the duty ratio in order to improve the problem of the unbalance of the amount of ions, it is possible to control the amount of +and −ions generated at the discharging electrode freely, so the remaining static electricity of the charged body can be eliminated more efficiently.

After all by controlling the frequency, according to the width of the bandwidth of +and −ions generated at said discharging electrode, the ions are sent corresponding to the distance to the charged body, and in case of eliminating remaining static electricity of the charged body by controlling the duty ratio, in order to generate more +ions the lasting time of +side of said AC pulse is set long, and in order to generate more −ions the lasting time of −side of said AC pulse is set long.

FIG. 5 is a flow chart about the operation of the controller (50). If AC pulse high voltage is applied to the discharging electrode (10) and starts operation by inputting the values of the frequency and the duty ratio of desired pulse AC voltage, analog signal (70) gets feedback and confirms the output state of the high voltage and in case of the output voltage goes down below the set level, eliminating static electricity is stopped ringing the alarm bell.

The change of frequency and duty ratio can be designed to be controllable by external remote controller, in this case by comparing the ID inputted from the remote controller, the microprocessor installed in the controller (50) changes the frequency and duty ratio when the ID set at each BAR is inputted, and the value set arbitrarily by the user is stored at EEPROM in the microprocessor so it remains though the source of electricity turns off and when the next source of electricity turns on it is applied as not being changed.

Meanwhile if a data communication module (54), for example RS-485 communication circuit, is installed in the controller (50), the works like operation, stoppage to the BAR, and change of set value can be done by using external PC, and the state of electrostatic eliminator installed at the work space can be grasped quickly by appointing a number of BAR as a group.

The characteristics of the microprocessor (PIC18F8520) installed in the controller to control the electrostatic eliminator of this invention is as follows.

TABLE 1

| | | |
|---|---|---|
| Program Memory | 128 | Kbyte |
| Data Memory | 3840 | Kbyte |
| EEPROM | 1024 | Kbyte |
| Operating Speed | 40 | MHz |

| | |
|---|---|
| I/O | 52 |
| ADC | 12 |
| Serial I/O (USART) | 2 |
| CCP(PWM) | 5 |
| Brown-Out Detection | YES |
| Timer | 5 |
| In-System Programing | YES |

As a preferred embodiment, the inputted analog voltage is converted as 0.019[V] per 1 bit and in case that the voltage level of the AC pulse high voltage is below 10 [kVpp] it can be designed to ring an alarm. The alarm is expressed as an LED of the front face and alarm bell, etc, and can be used as an output of a point of contact of RELAY at the UTP terminal.

The electrostatic eliminator (100) of this invention adopts pulse AC type to complement the defects of DC or AC type which has been used at the prior corona discharged electrostatic eliminator, that is to complement the restriction of installed distance to the charged body, the difficulty of controlling voltage of the remaining static electricity and the problem of eliminating the static electricity of a charged body moving fast, etc.

FIG. 6 illustrates the amount of ions generated by the corona discharged electrostatic eliminator of the previous AC high voltage type and FIG. 7 illustrates the amount of ions generated by the corona discharged electrostatic eliminator of the pulse AC high voltage style according to this invention. The area including + or − mark in FIG. 6 and FIG. 7 corresponds to the generated amount of ions. As illustrated, the square pulse signal that supplies + and −ions alternatively to the discharging electrode that generates corona discharge can get the maximum amount of ions per unit time, so it can save time to eliminate the static electricity to the highest degree.

In FIG. 7, the ratio of the time for generating +ions (t1) and −ions (t2), that is the duty ratio can be controlled freely. Therefore in case that there are more +ions in the remaining static electricity of the charged body extending the time for generating −ions (t2) by controlling the duty ratio is favorable, and in case that there are more −ions in the remaining static electricity of the charged body extending the time for generating +ions (t1) by controlling the duty ratio is favorable. Therefore controlling the duty ratio can make eliminating the remaining static electricity of the charged body efficiently.

By controlling the frequency of the pulse AC the installed distance to the charged body can be extended from short distance (50 mm) to long distance (maximum 2,500 mm), and by controlling the duty ratio of the pulse AC the voltage of the remaining static electricity can be maintained below ±10V to maximum.

Moreover in sending the + and −ions generated around the electrode to near the charged body, by injecting a dry air into the air vessel (60) and spraying it through the minute air nozzle (22) around the discharging electrode (10) the ions in the air are diffused sufficiently. Besides by making the shape of the air vessel (60) a cone and by making it possible for the air pressure of said air nozzle (22) to be maintained constantly, the amount of sprayed air of all minute air nozzle (22) can be maintained constantly.

### INDUSTRIAL APPLICABILITY

As a result of these characteristics, the electrostatic eliminator of this invention can also be used in producing liquid crystal display (LCD) suitably, especially suitable for the process of Hot/Cool plate, Photo Resistor Coating, Deposition, Exposure, Loader/Unloader, etc.

1. A corona discharged electrostatic eliminator using pulse AC high voltage, said eliminator comprising:
a discharging electrode generating a corona discharge;
a ground electrode inducing ion generation from said voltage applied discharging electrode;
a High voltage unit generating an AC pulse High Voltage and applying the high voltage to said discharging electrode; and
a controller to control the generated amount of +ions and −ions generated at said discharging electrode arbitrarily by controlling the frequency and duty ratio of said AC pulse high voltage, wherein
said eliminator is characterized in that by controlling the frequency, according to the width of the bandwidth of + and −ions generated at said discharging electrode, the ions are sent corresponding to the distance to a charged body,
and in case of eliminating remaining static electricity of the charged body by controlling the duty ratio, in order to generate more +ions the lasting time of +side of said AC pulse is set long, and in order to generate more −ions the lasting time of −side of said AC pulse is set long,
and the range of the frequency of the high voltage from said high voltage unit is from 1 [Hz] to 17 [kHz], and the duty ratio is controlled in the 40˜60[%] range.

2. The pulse AC high voltage electrostatic eliminator as set forth in claim 1, characterized by that said eliminator further comprises a discharging electrode socket at the center of which said discharging electrode is inserted and in which an air nozzle is formed to spray air of regular pressure, so that the ions generated at said discharging electrode can be sent to a charged body; and
an air vessel joined directly to said discharging electrode socket and supplying air injected through the air injection part to said air nozzle.

3. The pulse AC high voltage electrostatic eliminator as set forth in claim 2, characterized by that said air nozzle is positioned around the discharging electrode not less than one and has a form of a cylinder that passes through the inside of said discharging electrode socket.

4. The pulse AC high voltage electrostatic eliminator as set forth in claim 3, characterized by that the diameter of said air nozzle having a form of a cylinder is not greater than 1 mm.

5. The pulse AC high voltage electrostatic eliminator as set forth in claim 1, characterized by that a means of reducing the amount of the electric current flowing through the discharging electrode is connected to said discharging electrode.

6. The pulse AC high voltage electrostatic eliminator as set forth in claim 1, characterized by that said high voltage unit comprises
a transformer raising the input voltage;
a voltage multiplier receiving the raised voltage from said transformer and generating a high voltage that is applied to the discharging electrode; and
a pulse converter to convert the high voltage from said voltage multiplier to a pulse type.

7. The pulse AC high voltage electrostatic eliminator as set forth in claim 6, characterized by that said high voltage unit further comprises a feedback circuit that can get feedback of the drop in voltage by flowing the current through the grounded resistor connected to the secondary coil of the transformer if the current does not flow through the secondary coil of said transformer.

8. The pulse AC high voltage electrostatic eliminator as set forth in claim 1, characterized by that said controller comprises
an adjusting unit to adjust the frequency and the duty ratio of the pulse AC high voltage; and
a data communication module to confirm the status of said controller from an external computer by using data communication.

9. The pulse AC high voltage electrostatic eliminator as set forth in claim 8, characterized by that said controller further comprises a remote control signal receiving module to control the operation of said controller from the outside.

10. The pulse AC high voltage electrostatic eliminator as set forth in claim 1, characterized by that said eliminator is used in at least one of the process of producing Hot/Cool plate, Photo Resistor Coating, Deposition, Exposure, Loader/Unloader, and rubbing.
